(19) United States
(12) Patent Application Publication
(10) Pub. No.: US 2020/0281400 A1
(43) Pub. Date: Sep. 10, 2020

(54) A COOKER

(71) Applicant: ARCELIK ANONIM SIRKETI, Istanbul (TR)

(72) Inventors: Serdar Gokhan DOGANAY, Istanbul (TR); Bengul ASAR, Istanbul (TR)

(21) Appl. No.: 16/068,086

(22) PCT Filed: Jan. 5, 2017
(86) PCT No.: PCT/EP2017/050174

§ 371 Date: Jul. 3, 2018

(30) Foreign Application Priority Data
Jan. 5, 2016 (TR) 2016/00114

(51) Int. Cl. A47J 37/06; F24C 15/00; G01K 13/00; A47J 36/32

(52) U.S. Cl. CPC A47J 37/0664; F24C 15/00; A47J 2202/00; A47J 36/32; G01K 2207/06; G01K 13/00

(57) ABSTRACT

The present invention relates to a cooker comprising a body; a cooking chamber that is disposed on the body and wherein foods to be cooked are placed, and a probe that is disposed in the cooking chamber and that has at least one probe end measuring the humidity and/or temperature by being placed into the food.

The present invention relates to a cooker comprising a probe.

Cooking foods in the desired level is important in terms of both user satisfaction and the foods keeping their vitamins. In overcooked foods, vitamin values substantially decrease. Moreover, in undercooked foods, particularly in meats, there is high possibility of bacteria growth. Undercooked foods may cause food poisoning. Therefore, foods, particularly meats must be cooked in the ideal level without losing their vitamins. While large foods such as chicken, etc., are being cooked, the outer surfaces can be overcooked while the inside may remain uncooked. Nowadays, probes are used in many ovens to prevent this problem. The probe is placed onto the food being cooked. The probes having a plurality of receivers determine the central temperature of the food, thus providing ideal cooking. Nowadays, flavoring processes are applied to foods such as meat, etc. with various aromas according to the palate. In domestic ovens, the users prefer this kind of aromatization methods. However, what is important in the aromatization process is to apply the method to the food at the right time according to the temperature of the food. Frequently, since the aroma is not homogeneously distributed on the food, dense aroma flavor on some of the regions of the food disturbs the user and on some regions the user cannot taste the desired aroma.

In the state of the art U.S. Pat. No. 6,855,357, a cooking apparatus that diffuses aroma onto the food during the cooking process is disclosed.

The aim of the present invention is the realization of a cooker wherein the food can be cooked in the desired level and the aromatization process can be carried out at the right time during the cooking process.

The cooker realized in order to attain the aim of the present invention, explicated in the first claim and the respective claims thereof, comprises a body; a cooking chamber that is disposed on the body and wherein the cooking process is performed, and a probe that is disposed in the cooking chamber. By means of the probe, ideal cooking levels can be reached according to the user preference.

The cooker of the present invention comprises an aroma chamber wherein aroma can be added by the user and an aroma channel that provides the delivery of the aroma from the aroma chamber to the probe end. The aroma is added to the aroma chamber by the user. The aroma channel that extends from the aroma chamber to the probe end provides the delivery of the aroma.

In an embodiment of the present invention, the cooker comprises a sensor that is disposed at the probe end. By means of the sensor, temperature and/or humidity data can be received from the food. The cooking process is controlled by means of a control unit depending on the information received from the sensor.

In an embodiment of the present invention, the cooker comprises the control unit wherein the aromatization time is predefined. The best time to send the aroma onto the food is predefined in the control unit.

In an embodiment of the present invention, the cooker comprises a valve that is disposed between the aroma chamber and the aroma channel. The valve is controlled by the control unit. Thus, the aroma is enabled to be delivered from the aroma chamber to the probe end through the aroma channel.

In an embodiment of the present invention, the cooker comprises a control panel that is disposed on the body and an aroma control button that is disposed on the control panel. When the aroma control button is actuated by the user, the control unit provides the delivery of the aroma onto the food.

In an embodiment of the present invention, the cooker comprises an aroma level button that is disposed on the control panel and the control unit that delivers the aroma onto the food in various amounts depending on the selected aroma level. Thus, the user can adjust the level of the aroma flavor.

In an embodiment of the present invention, the probe comprises more than one probe end.

The cooker realized in order to attain the aim of the present invention is illustrated in the attached figures where

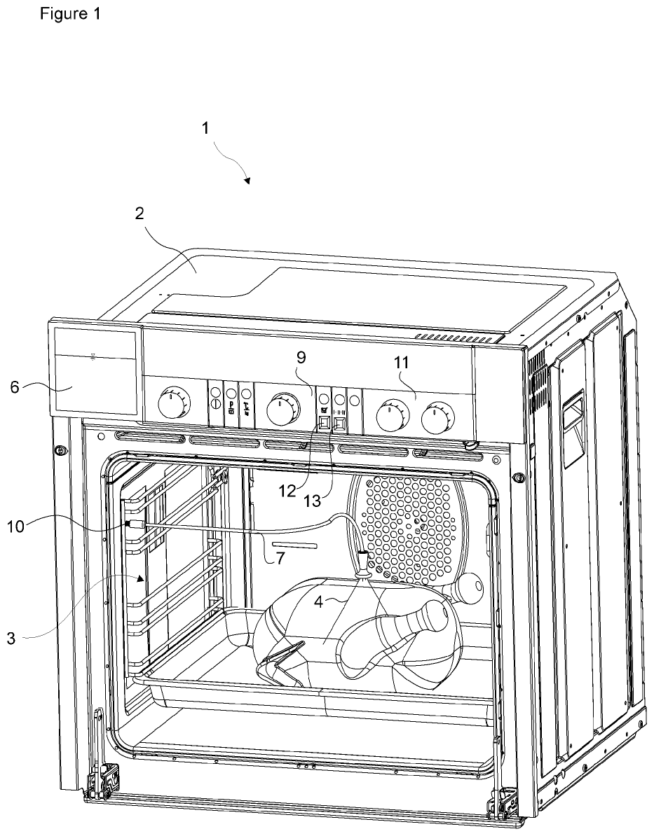

FIG. 1—is the schematic view of the cooker.

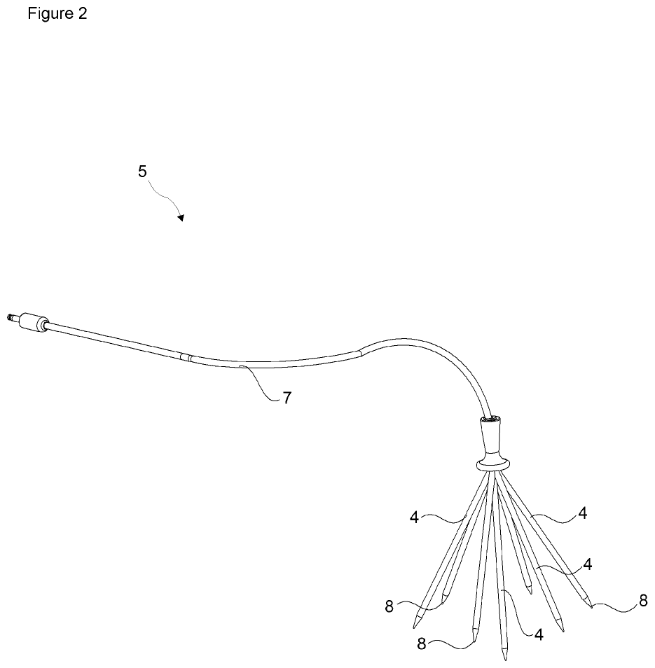

FIG. 2—is the schematic view of the probe.

The elements illustrated in the figures are numbered as follows:
1. Cooker
2. Body
3. Cooking chamber
4. Probe end
5. Probe
6. Aroma chamber
7. Aroma channel
8. Sensor
9. Control unit
10. Valve
11. Control panel
12. Aroma control button
13. Aroma level button

The cooker (1) comprises a body (2); a cooking chamber (3) that is disposed on the body (2) and wherein foods to be cooked are placed, and a probe (5) that is disposed in the cooking chamber (3) and that has at least one probe end (4) measuring the humidity and/or temperature by being placed into the food. By means of the probe (5), the foods are cooked at the level desired by the user. (FIG. 1).

The cooker (1) of the present invention comprises an aroma chamber (6) that is disposed on the body (2) and wherein aroma can be added by the user, an aroma channel (7) with one end opening to the aroma chamber (6) and the other end to the probe (5), and the probe end (4) that provides the distribution of the aroma inside the food. The aroma channel (7) extends along the probe (5). The aroma reaches the food by moving through the aroma channel (7). By means of the probe end (4), the aroma is injected into the food. The user can add the desired aroma into the aroma chamber (6). Thus, ease of utilization is provided (FIG. 2).

In an embodiment of the present invention, the cooker (1) comprises a sensor (8) that is disposed on the probe end (4) and a control unit (9) that controls the cooking process according to the humidity and/or temperature values received from the sensor (8). By means of the control unit (9), the cooking level of the probe is determined according to the information received from the probe ends (4). Thus, the cooking level desired by the user is obtained.

In a derivative of this embodiment, the control unit (9) comprises an aroma time (ta) that is predefined by the user and at which the aroma is homogeneously distributed over the food and warns the user at the aroma time (ta). It is important to carry out the aromatization process at the right time. The aromatization process is performed when the outer surface of the food is cooked, but the inside is not completely cooked. The outer surface serves as a shell over the food and the aroma can be homogeneously distributed in the food. The aroma time (ta) is defined on the control unit (9) with an algorithm. The control unit (9) determines the aromatization time according to the temperature and humidity values received from the sensors (8) and warns the user.

In an embodiment of the present invention, the cooker (1) comprises a valve (10) that is disposed on the aroma chamber (6), that is controlled by the control unit (9) and that provides or prevents the passage of the aroma from the aroma chamber (6) to the aroma channel (7). The valve (10) is disposed between the aroma chamber (6) and the aroma channel (7). With the command sent by the control unit (9), the valve (10) provides the passage of the aroma into the aroma channel (7).

In an embodiment of the present invention, the cooker (1) comprises a control panel (11) that is disposed on the body (2) and that enables the user to select the cooking parameters, and an aroma control button (12) that is disposed on the control panel (11) and that provides the delivery of the aroma from the aroma chamber (6) to the food when triggered. When the aroma time (ta) comes after the user starts the cooking process while the aroma control button (12) is active, the aroma is automatically delivered onto the food by the control unit (9). The user can cancel the aromatization process by changing the aroma control button (12) to the passive position.

In an embodiment of the present invention, the cooker (1) comprises an aroma level button (13) that enables the aroma density to be defined by the user from the control panel (11) and the control unit (9) that delivers the aroma onto the food in various amounts depending on the selected aroma level. The user can adjust the aroma density according to his/her preference. While less aroma can provide the desired flavor in small foods, a higher amount of aroma can be required in large foods. The user can select the aroma level according to his/her palate and starts the cooking process.

In an embodiment of the present invention, the probe (5) comprises more than one probe end (4). The aroma can be homogeneously distributed over the food with the probe ends (4) contacting the different points of the food.

By means of the cooker (1) of the present invention, the desired cooking level is provided and the aromatization process can be realized at the desired density and in a homogeneous manner. Thus, the user satisfaction is increased and the aromatization process can be performed at the ideal level in the domestic environment.

1. A cooker comprising a body; a cooking chamber that is disposed on the body and wherein foods to be cooked are placed, and a probe that is disposed in the cooking chamber and that has at least one probe end measuring the humidity and/or temperature by being placed into the food, characterized by an aroma chamber that is disposed on the body and wherein aroma can be added by the user, an aroma channel with one end opening to the aroma chamber and the other end to the probe, and the probe end that provides the distribution of the aroma inside the food.

2. The cooker as in claim 1, characterized by a sensor that is disposed on the probe end and a control unit that controls the cooking process according to the humidity and/or temperature values received from the sensor.

3. The cooker as in claim 2, characterized by an aroma time that is predefined on the control unit by the user and at which the aroma is homogeneously distributed over the food and the control unit that warns the user at the aroma time.

4. The cooker as in claim 2, characterized by a valve that is disposed on the aroma chamber, that is controlled by the control unit and that provides or prevents the passage of the aroma from the aroma chamber to the aroma channel.

5. The cooker as in claim 1, characterized by a control panel that is disposed on the body and that enables the user to select the cooking parameters, and an aroma control button that is disposed on the control panel and that provides the delivery of the aroma from the aroma chamber to the food when triggered.

6. The cooker as in claim 2, characterized by an aroma level button that enables the aroma density to be defined by the user from the control panel and the control unit that delivers the aroma onto the food in various amounts depending on the selected aroma level.

7. The cooker as in claim 1, characterized by the probe comprising more than one probe end.
